(19) United States
(12) Patent Application Publication
(10) Pub. No.: US 2003/0034652 A1
(43) Pub. Date: Feb. 20, 2003

(54) Roadway electric generator

(76) Inventor: Jeffrey H. Slatkin, North Bellmore, NY (US)

Correspondence Address: RANDAL D. HOMBURG, Attorney at Law, P.O. Box 10470, MIDWEST CITY, OK, 73140-1470, US

(21) Appl. No.: 09/931,042

(22) Filed: Aug. 16, 2001

(51) Int. Cl. H02P 9/04

(52) U.S. Cl. 290/1 R

(57) ABSTRACT

The invention is an electrical generating device and method utilizing the potential energy of moving traffic on highways to generate three phase electrical current, the device comprising a large plurality of compressible electrical generator pumps underneath upper and lower plates located between the road bed and the travel surface of the highway activated by the compression weight of a moving vehicle over the travel surface of the roadway.

### CROSS REFERENCE TO RELATED APPLICATIONS

None

### I. BACKGROUND OF THE INVENTION

1. Field of Invention

The invention is an electrical generating device and method utilizing the potential energy of moving traffic on highways to generate three phase electrical current, the device comprising a large plurality of compressible electrical generator pumps underneath upper and lower plates located between the road bed and the travel surface of the highway activated by the compression weight of a moving vehicle over the travel surface of the roadway.

2. Description of Prior Art

The following United States patents were discovered and are disclosed within this application for utility patent. All relate to electrical devices located in a roadway, most of them pertaining to traffic control sensing devices. None of these located prior art patents have the capacity for the generation of electrical energy.

In U.S. Pat. No. 3,535,923 to Martorana, et al., a load sensing transducer located underneath a roadbed is disclosed, the device comprising a deformable member positioned between two rigid load-receiving bodies providing a means of determining the load stress of a body resting on the upper surface of the device, more specifically disclosed as two rigid load receiving bodies forming a bridge, at least one load sensing element, a resilient means between the two load receiving bodies, and annular member of a suitably deformed material subject to the bending force of an applied load, and two tubular extensions tensioned together holding the device together.

Weight detection devices installed in roadways are disclosed in U.S. Pat. Nos. 5,461,924 to Calderara, et al., and 4,799,381 to Tromp, the devices having a compressible means to indicate the weight of a passing vehicle over the device embedded in a roadway. In Tromp, a vehicle road sensor, using an electrical current interruption is provided, the weight of the passing vehicle over the top of the device providing a measured resistance to the electrical current flow through the device, the device having a measuring means to convert a reading of the measured electrical resistance to a calibrated weight of the passing vehicle.

Similarly, U.S. Pat. No. 5,942,681 to Vollenweider, et al. provides a tire pressure measuring surface installed in roadways having a measuring rail with multiple individual measuring elements with sensors disposed in a line transverse to a direction of travel, each sensor having a force introducing flange and an opposed force sustaining flange and a contact rail to measure the speed of the vehicle determining the speed and the tire inflation pressure of the vehicular tires passing over the device.

Of those prior art patents which do deal with the production of electricity using roadway traffic, nearly all of them deal with either large generator wheels or they deal with fluid filled bladders and the conversion of downward mechanical force to hydro-fluid generators for their energy production. Those patents include U.S. Pat. Nos. 5,355,674 to Rosenberg and 6,172,426 to Galich.

In U.S. Pat. No. 4,924,123 to Hamajima, a linear generator is disclosed, the device utilizing a series of magnets on a spinning shaft relating to magnets fixed across from the magnets of the shaft connected to electrical coils in which the spinning shaft creates electromagnetic energy infused into the coils, thus generating electrical current. However, it has no application to roadway or traffic use for the generation of the energy source.

### II. SUMMARY OF THE INVENTION

The primary objective of the invention is to provide a method and means of generating usable electrical energy in a clean and efficient manner utilizing potential energy from an abundant and unused energy source using a series of plates containing electrical generators embedded within a roadway to generate electrical current using mechanical means. A second objective is to provide a method and device for the generation of three phase electrical energy which requires no additional fuel to produce such electrical energy, other than that fuel already in use for other purposes, i.e., transportation. A third objective is to provide a method and means of generating such electrical energy in a purely mechanical form without utilizing a fluid activated generation means.

In the present device, the electrical generation is performed by the movement of a multiplicity of mechanical pumps which generate electrical current, preferably three phase current, by motion using an electrical generator means having a drive gear which engages a descending driver arm of each of a large plurality of electrical generator cells.

### III. DESCRIPTION OF THE DRAWINGS

The following drawings are submitted with this utility patent application.

FIG. 1 is a side view of the device in relation to a roadway.

FIG. 2 is a side view of one of the electrical generator cells.

FIG. 3 is a diagram of a Y-connected three phase, four wire generator circuit diagrams.

FIG. 4 is a diagram of a vehicle passing over the device indicating the compression of the device as a vehicle passes over the device.

### IV. DESCRIPTION OF THE PREFERRED EMBODIMENT

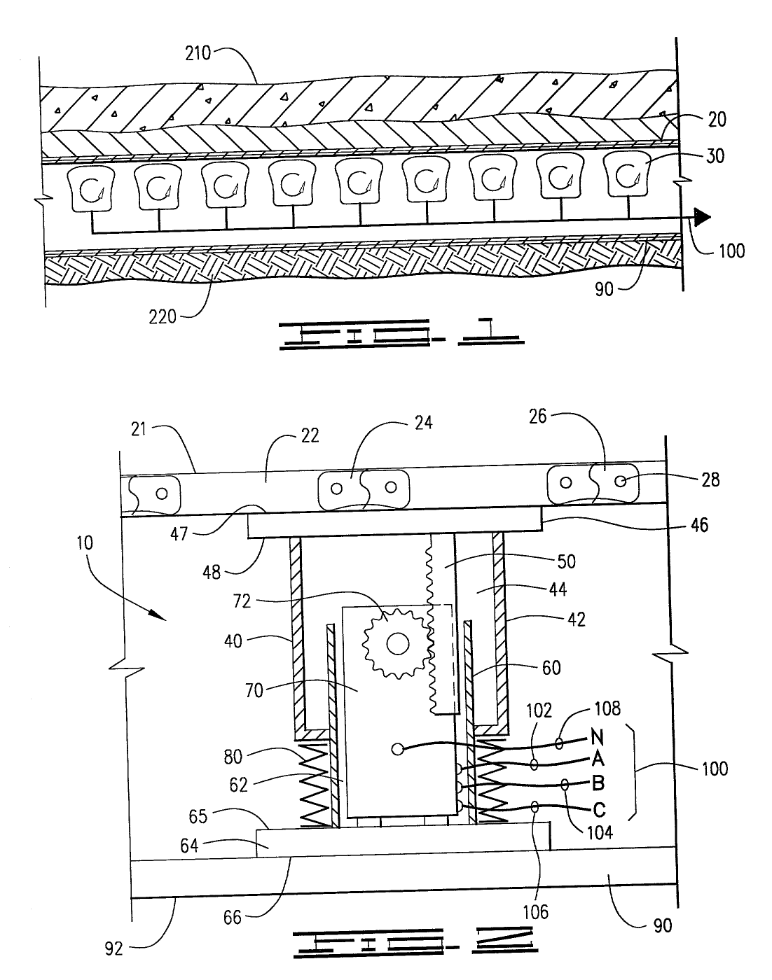

The invention is a device and method of producing electrical energy by using the potential energy of automobile traffic in a roadway 200, the device 10, as shown in FIGS. 1-4 of the drawings, comprising a deformable upper plate 20, a plurality of electro-mechanical generating pumps 30 producing a usable electrical current, a rigid lower plate 90, and electrical conductor wires 100, the device embedded within the roadway 200 wherein passing vehicular traffic compresses the deformable upper plate 20, compressing the electro-mechanical generating pumps 30 between the deformable upper plate 20 and the rigid lower plate 90, such compression producing such usable electrical current through the electrical conductor wires 100.

In furtherance of this invention, the deformable upper plate 20, as shown in FIGS. 2 and 4 of the drawings, has an upper surface 21, and is a series of individual rigid tread plates 22 linked together by a linking means 24, which, in a preferred embodiment, may be a linking plate 26 and linking pins 28. The individual rigid tread plates 22 must be of a nature and material which will not permanently deform when subjected to repeated exposure to heavy traffic conditions over time. In this regard, the deformable upper plate 22 should be placed below a paved road surface 210.

The rigid lower plate 90, having a lower surface 92, may be a single sheet of material which will not be deformed over time by the constant flow of traffic. In this sense, the installation of the rigid lower plate 90 must be made upon a solid and firm roadbed 220 prohibiting penetration of the lower surface 92 of the rigid lower plate 90 into the surface of the roadbed 220 below.

The electro-mechanical generating pumps 30, as shown in FIG. 2 of the drawings, have a means of generating electrical current 40. In a preferred embodiment, this means 40 may comprise an upper piston cap 42 having an interior cavity 44 and a top endpiece 46, a base piston shell 60 having an interior cavity 62 and a base member 64, the upper piston cap 42 and the base piston shell 60 being compressibly connected by at least one spring 80. The top endpiece 46 has an upper surface 47 and a lower surface 48 from which a descending driver arm 50 extends into the interior cavity 44. The base member 60 has an upper surface 65 and a lower surface 66, wherein an electrical generator 70 is affixed to the upper surface 65, the electrical generator 70 having a drive gear 72 which engages the descending driver arm 50 attached to the top endpiece 46. The electrical conductor wires 100 extend through the base piston shell 60 to connect such electrical conductor wires 100 to an electrical apparatus or to a location where generated electrical current may be stored or collected for remote use. The electrical generator 70 should be insulated from the base piston shell 60 to which it is affixed.

Installation of the device 10 could occur either in the initial construction of the roadway 200 or performed on an existing roadway. The device 10 would best be supplied for installation in an assembled component state including the deformable upper plate 20, the plurality of electro-mechanical generating pumps 30 producing a usable electrical current, the rigid lower plate 90 and the electrical conductor wires 100. The lower surface 92 of the rigid lower plate 90 is placed on an exposed firm roadbed 220, and the paved road surface 210 is applied over the upper surface 21 of the deformable upper plate 20. Once placed, the device 10 is activated to produce the electrical energy as a vehicle is passed over the roadway compressing the electro-mechanical generating pumps 30 sandwiched between the deformable upper plate 21 and the rigid lower plate 90. After the vehicle has passed, the electro-mechanical generating pumps 30 return to their expanded state awaiting the weight of another passing vehicle to activate the electro-mechanical generating pumps 30.

The method of producing electrical energy by using the potential energy of automobile traffic in a roadway comprises the steps of providing a device 10 having a deformable upper plate 20, a plurality of electro-mechanical generator pumps 30, a rigid lower plate 90 and electrical conductor wires 100 whereby compression of the electro-mechanical generating pumps 30 between the deformable upper plate 20 and the rigid lower plate 90 produces a usable electrical current through the electrical conductor wires 100, preparing a roadbed 220 to firmly support the device 10, placing the device 10 on the prepared roadbed 220, applying a paved road surface 210 over the device 10 which would allow vehicular traffic to pass over such paved road surface 210, attaching the electrical conductor wires 100 to an electrical apparatus or to a location where generated electrical current may be stored or collected for remote use.

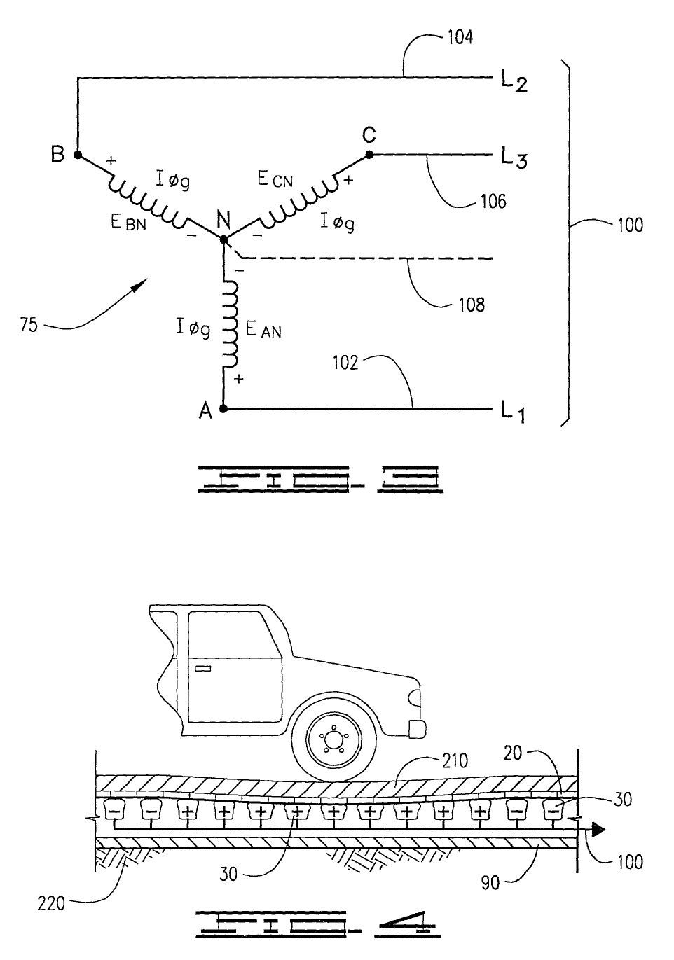

In a preferred embodiment, the electrical generator 70 would be a Y-connected three phase, four wire electrical generator 75, having a circuit diagram as shown in FIG. 3 of the drawings, supplying an A phase 102, a B phase 104, a C phase 106 and a neutral phase wire 108 as the electrical conductor wires 100. However, any electrical generator which produces electrical power would also be included within the scope of this invention as the electrical generator 75.

While the invention has been particularly shown and described with reference to a preferred embodiment thereof, it will be understood by those skilled in the art that changes in form and detail may be made therein without departing from the spirit and scope of the invention.

What is claimed is:

1. A device for producing electrical energy by using the potential energy of automobile traffic in a roadway comprising:
a. a deformable upper plate;
b. a plurality of electro-mechanical generating pumps producing a usable electrical current;
c. a rigid lower plate; and
d. electrical conductor wires, the device embedded within the roadway wherein passing vehicular traffic compresses the deformable upper plate, compressing the electro-mechanical generating pumps between the deformable upper plate and the rigid lower plate, such compression producing such usable electrical current through the electrical conductor wires.

2. A device for producing electrical energy by using the potential energy of automobile traffic in a roadway comprising:
a. a deformable upper plate having an upper surface, a series of individual rigid tread plates linked together by a linking plate and linking pins, the individual rigid tread plates of a nature and material which will not permanently deform when subjected to repeated exposure to heavy traffic conditions over time;
b. a rigid lower plate, having a lower surface, which is a single sheet of material which will not be deformed over time by the constant flow of traffic;
c. an electro-mechanical generating pumps, having a means of producing electrical current, such means further comprising:
i. an upper piston cap having an interior cavity and a top endpiece, the top endpiece having an upper surface and a lower surface from which a descending driver arm extends into the interior cavity;
ii. a base piston shell having an interior cavity and a base member, the upper piston cap and the base piston shell being compressibly connected by at least one spring, such base member having an upper surface and a lower surface; and
iii. an electrical generator affixed to the upper surface of the base member, the electrical generator having a drive gear engaging the descending driver arm attached to the top endpiece; and
d. electrical conductor wires extending through the base piston shell connecting the electrical conductor wires to an electrical apparatus or to a location where generated electrical current may be stored or collected for remote use.

3. The device, as disclosed in claim 2, wherein the electrical generator is a Y-connected four wire, three phase electrical generator supplying an A phase, a B phase, a C phase and a neutral phase wire as the electrical conductor wires.

4. The device as disclosed in claim 2, the device installed in the roadway wherein the lower surface of the rigid lower plate is placed on an exposed firm roadbed, after which a paved road surface is applied over the upper surface of the deformable upper plate, the installed device thereafter producing electrical energy when a vehicle passes over the paved road surface compressing the electro-mechanical generating pumps between the deformable upper plate and the rigid lower plate, the electro-mechanical generating pumps returning to their expanded state awaiting the weight of another passing vehicle activating the electro-mechanical generating pumps.

5. A method of producing electrical energy by using the potential energy of automobile traffic in a roadway comprises the steps of:
a. providing a device having a deformable upper plate, a plurality of electro-mechanical generator pumps, a rigid lower plate and electrical conductor wires whereby compression of the electro-mechanical generating pumps between the deformable upper plate and the rigid lower plate produces a usable electrical current through the electrical conductor wires;
b. preparing a roadbed to firmly support the device;
c. placing the device on the prepared roadbed;
d. applying a paved road surface over the device which would allow vehicular traffic to pass over such paved road surface; and
e. attaching the electrical conductor wires to an electrical apparatus or to a location where generated electrical current may be stored or collected for remote use.
